(19) United States
(12) Patent Application Publication
(10) Pub. No.: US 2017/0301271 A1
(43) Pub. Date: Oct. 19, 2017

(54) DIGITAL SIGNAGE ABNORMALITY DETECTION METHOD AND APPARATUS THEREFOR

(71) Applicant: KNOWCK CO., LTD., Seoul (KR)

(72) Inventor: Jeung Ho KIM, Seoul (KR)

(21) Appl. No.: 15/315,203

(22) PCT Filed: Oct. 28, 2015
(86) PCT No.: PCT/KR2015/011450

§ 371 Date: Nov. 30, 2016

(51) Int. Cl. G09G 3/00

(52) U.S. Cl. CPC G09G 3/006

(57) ABSTRACT

A digital signage abnormality detection method of detecting presence or absence of an abnormality of a digital signage including a display includes measuring current or voltage data applied to the display; determining presence or absence of an abnormality of the display by analyzing the measured current or voltage data; and transmitting the determination result regarding the presence or absence of the abnormality of the display to a manager of the digital signage. In the process of determining presence or absence of the abnormality, the presence or absence of the abnormality is determined by comparing the measured current or voltage data with current or voltage data obtained when the display is in a normal state.

### TECHNICAL FIELD

The various embodiments described herein pertain generally to a digital signage abnormality detection method and an apparatus therefor; and, more particularly, to a method of detecting presence or absence of an abnormality of a digital signage by measuring a current or a voltage applied to a display of the digital signage and an apparatus therefor.

### BACKGROUND

A digital signage is a digital medium which is installed in public places, commercial facilities, etc., to provide information, entertainment, and advertisement services. Recently, with the development of information and communications technology and wide-spread utilization of digital displays, the range of application of the digital signage is getting enlarged, and the digital signage is attracting attention as the fourth medium following TV, Internet and mobile.

A traditional digital signage has been run and managed in a fixed outdoor place. Recently, however, the application of the digital signage has been extended to everywhere people use, for example, public transportations such as bus, taxi and subway as well as buildings and shopping malls. From the viewpoint of a manager, general environment is changing greatly, and such new environment includes the common use of mobile devices such as smart phones or pads, for example.

Meanwhile, in the digital signage, even if data is normally transmitted, a part of or the whole of a display of the digital signage may be turned out and a screen may not be displayed normally. To check the state of the display, the manager needs to investigate the display directly at the place where the digital signage is installed. In the current environment where the manager remote-controls a multiple number of digital signages, however, there are many realistic difficulties for the manager to check presence or absence of an abnormality of the display directly.

Thus, even if an error or an abnormality occurs in the digital signage, the manager may not check it immediately and may fail to take a measure to the problem in a timely manner, resulting in mal-functioning of the digital signage.

### DISCLOSURE OF THE INVENTION

### Problems to be Solved by the Invention

Example embodiments of the present disclosure provide a digital signage abnormality detection method capable of allowing a manager to easily check whether or not a digital signage is operating normally without needing to go to a place where the digital signage is installed. Further, example embodiments also provide an apparatus for implementing this method.

However, the problems sought to be solved by the present disclosure are not limited to the above description and other problems can be clearly understood by those skilled in the art from the following description.

### Means for Solving the Problems

In one example embodiment, a digital signage abnormality detection method of detecting presence or absence of an abnormality of a digital signage including a display includes measuring current or voltage data applied to the display; determining presence or absence of an abnormality of the display by analyzing the measured current or voltage data; and transmitting the determination result regarding the presence or absence of the abnormality of the display to a manager of the digital signage. In the process of determining presence or absence of the abnormality, the presence or absence of the abnormality is determined by comparing the measured current or voltage data with current or voltage data obtained when the display is in a normal state.

In the process of determining the presence or absence of the abnormality, a type of the abnormality of the display may be determined by comparing the measured current or voltage data with a plurality of current or voltage data which correspond to abnormality types of the display

In the process of determining the presence or absence of the abnormality, current or voltage data obtained when the display is in a normal state may be compensated according to an operating time of the display and the compensated current or voltage data is compared with the measured current or voltage data.

The digital signage abnormality detection method may further include capturing an image of the display; compensating the captured image of the display. The capturing the image of the display may be performed in response to a command from the manager of the digital signage after the determination result regarding the presence or absence of the abnormality of the display is transmitted to the manager of the digital signage.

In another exemplary embodiment, a digital signage abnormality detection apparatus which detects an abnormality of a digital signage including a display includes a measuring unit configured to measure current or voltage data applied to the display; a data measurement unit configured to determine presence or absence of an abnormality by analyzing the measured current or voltage data; and a data transmission/reception unit configured to transmit the determination result obtained by the data measurement unit to a manager of the digital signage. The data measurement unit may store a current or voltage data obtained when the display is in a normal state, and determine presence or absence of the abnormality by comparing the measured current or voltage data with the previously stored current or voltage data.

### Effect of the Invention

According to the example embodiments, if an abnormality occurs in a digital signage, a manager can check it easily anywhere. Accordingly, even if an abnormality of the digital signage occurs, a proper measure can be taken in a timely manner, so that the digital signage is allowed to perform its function normally.

### BRIEF DESCRIPTION OF THE DRAWINGS

FIG. 1 is a diagram illustrating a schematic configuration of an entire system for providing contents by using a digital signage according to an example embodiment.

FIG. 2 is a diagram illustrating a configuration of the digital signage including a display abnormality detection apparatus according to the example embodiment.

FIG. 3 is a diagram showing a process of detecting an abnormality of the display of the digital signage according to the example embodiment.

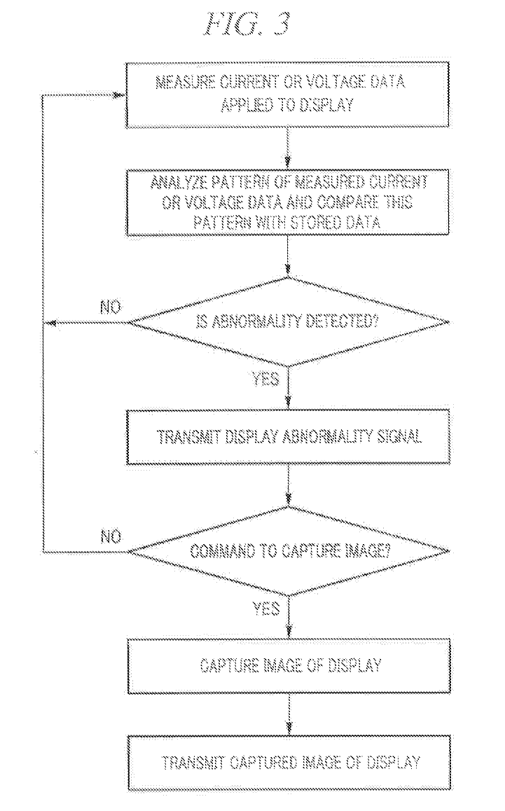

### EXPLANATION OF REFERENCE NUMERALS

100: communications network

200: contents providing system

300: manager terminal device

400: digital signage

410: display

420: digital signage abnormality detection apparatus

421: current/voltage measuring unit

423 data processing unit:

425: data transmission/reception unit

427: display imaging unit

429: control unit

### Mode for Carrying Out the Invention

Hereinafter, example embodiments will be described in detail so that inventive concept may be readily implemented by those skilled in the art.

In drawings, parts not directly relevant to the description are omitted to enhance the clarity of the drawings, and like reference numerals denote like parts through the whole document. Further, sizes of the parts shown in the drawings are nothing more than examples for the purpose of illustration and thus are not meant to be anyway limiting.

Specific shapes, structures and features described in the document may be modified without departing from the technical concept and scope of the present disclosure, and positions or layout of individual parts may also be changed or modified without departing from the technical concept and scope of the present disclosure. Thus, it is to be noted that the example embodiments to be describe below are not intended to be anyway limiting and various modifications may be made. The scope of the inventive concept is defined by the following claims and their equivalents rather than by the detailed description of the illustrative embodiments. It shall be understood that all modifications and embodiments conceived from the meaning and scope of the claims and their equivalents are included in the scope of the inventive concept.

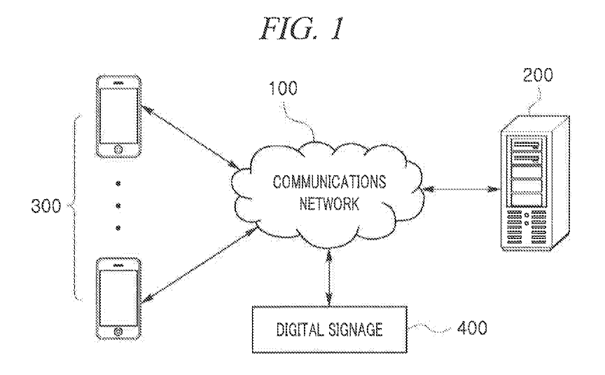

FIG. 1 is a diagram illustrating a schematic configuration of an entire system configured to provide contents by using a digital signage according to an example embodiment.

Referring to FIG. 1, the entire system of the digital signage according to the example embodiment includes a communications network 100, a contents providing system 200, a manager terminal device 300 and a digital signage 400.

First, the communication network 100 according to the example embodiment may be implemented by wired or wireless communications networks. Specifically, the communications network 100 may be implemented by any of various communications networks such as a LAN (Local Area Network), a MAN (Metropolitan Area Network), a WAN (Wide Area Network), and so forth. Desirably, the communications network 100 in this example embodiment may be implemented by a well-known internet or WWW (World Wide Web). However, the communications network 100 is not limited to the mentioned examples, and may include a commonly known wired or wireless data communications network, a commonly known telephone network, or a commonly known wired or wireless television broadcasting network as at least a part thereof.

The contents providing system 200 according to the example embodiment is configured to perform a pre-processing of classifying contents collected through the communications network into at least one contents unit and re-structure the contents by determining a provision state of the at least one contents unit while referring to at least one of state information of the digital signage to which the contents are to be provided and setting information input from a manager who manages the contents, thus allowing the format or the content of the contents provided through the digital signage to be automatically re-structured to be suitable for the condition involved.

However, it should be noted that the above description for the contents providing system 200 is nothing more than an example, and at least a part of functions or constituent components of the contents providing server 200 may be realized within the manager terminal device 300 or the digital signage 400, or included in the manager terminal device 300 or the digital signage 400 when necessary.

The manager terminal device 300 according to the example embodiment is a digital device having a function of allowing the manager to access and communicate with the contents providing system 200. This manager terminal device 300 is not particularly limited as long as it is implemented by a digital device equipped with a memory and a microprocessor and thus has an operation ability. By way of non-limiting example, a smart phone, a tablet, a desktop computer, a laptop computer, a workstation, a PDA, a web pad, a mobile phone, or the like may be used as the manager terminal device 300.

Further, according to the example embodiment, the manager terminal device 300 may include an application (not shown) which supports the manager to input various setting information necessary for the manager to restructure the contents or the state information of the digital signage. This application may be downloaded from the contents providing system 200 or a commonly known web server (not shown), or at least a part of the application may be replaced by a hardware device or a firmware device capable of performing substantially the same or equivalent function as that of the application, when necessary.

According to the example embodiment, the digital signage 400 is capable of performing a function of receiving the contents restructured by the contents providing system 200 and providing users with the restructured contents. To elaborate, the digital signage 400 may include a display device (display) such as a LCD panel or an OLED panel, and may further include an audio equipment such as a speaker for sound output. According to the example embodiment, the digital signage 400 may be installed in public places such as a department store, a subway, a bus stop, an air port, a hotel, a hospital, and so forth. However, it should be nosed that these installation places are just examples, and the place where the digital signage 400 is installed is not limited to the aforementioned examples.

Information upon the specification of the digital signage 400 and information upon an identifier of the place where the digital signage 400 is installed may be provided to the contents providing system 200 as the state information of the digital signage 400.

Meanwhile, even if the contents are normally transmitted to the digital signage 400, the signage 400 may not perform its function normally if the whole or a part of the display thereof malfunctions. In general, it needs to be checked by a manager with naked eyes whether the display of the digital signage 400 is operating normally. However, there are many realistic difficulties for the manger to directly investigate the states of all digital signages installed in vast areas individually.

In this regard, the present disclosure is characterized in providing an apparatus capable of investigating a state of the digital signage promptly and accurately. Hereinafter, a digital signage abnormality detection apparatus will be discussed in detail.

### Configuration of Digital Signage Abnormality Detection Apparatus

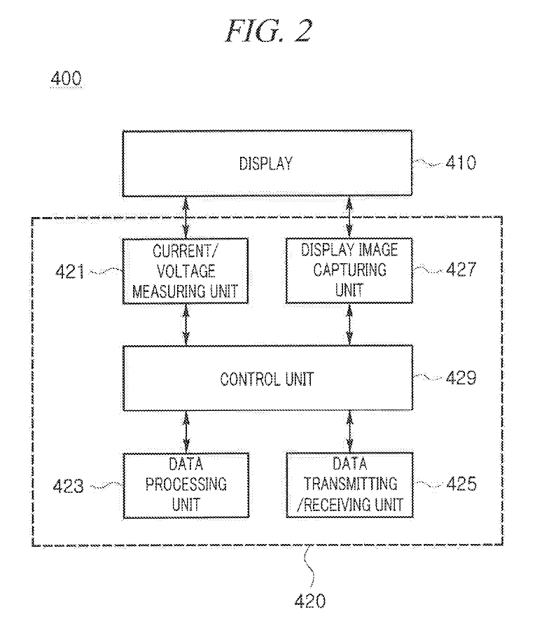

FIG. 2 is a diagram illustrating a configuration of the digital signage including a digital signage abnormality detection apparatus configured to detect an abnormality of the display of the digital signage according to an example embodiment.

As depicted in FIG. 2, the digital signage 400 according to the example embodiment includes a display 410 and a digital signage abnormality detection apparatus 420 configured to detect an abnormality of the display 410. Further, the digital signage abnormality detection apparatus 420 is equipped with a current/voltage measuring unit 421, a data processing unit 423, a data transmission/reception unit 425, a display imaging unit 427 and a control unit 429.

The current/voltage measuring unit 421 of the digital signage abnormality detection apparatus 420 is configured to acquire current or voltage data by measuring a current or a voltage applied to the display 410. This current/voltage measuring unit 421 may be implemented by a commonly known ampere meter or voltmeter connected to a display. For the connection to the display, any of various types of connection schemes can be adopted as long as the connection enables the current or the voltage to be measured.

The data processing unit 423 is configured to analyze the current/voltage data acquired by the current/voltage measuring unit 421 and determine presence or absence of an abnormality of the display 410.

A current or a voltage applied to the display in a normal state has a regular pattern. If, however, a part of pixels of the display 410 is abnormal, the pattern of the current or the voltage is changed. In view of this, according to the example embodiment, the data processing unit 423 stores data upon the current/voltage applied to the display in the normal state as a reference, and it can be determined presence or absence of an abnormality by comparing this reference current/voltage data with the current/voltage data acquired by the current/voltage measuring unit 421.

Furthermore, the pattern of the current/voltage differs depending on the degree of the abnormality of the display. For example, assume a case where a certain region of the display is completely broken and cannot be restored and a case where that region is kept turned on and off repeatedly, the pattern of the current/voltage is different between these two cases. That is, the current/voltage exhibits a certain pattern depending on the state of the display. Thus, in the present example embodiment, the data processing unit 423 may store patterns of current/voltage data depending on different states of the display, and may determine presence or absence of an abnormality of the display by comparing these patterns with the current/voltage data acquired by the current/voltage measuring unit 421.

As a result of the analysis of the current/voltage data by the data processing unit 423, if the display is found to have an abnormality, the data transmission/reception unit 425 serves to transmit this analysis result to the manager terminal device 300. Further, in case that the manager sends a command to capture an image of the display through the manager terminal device 300, the data transmission/reception unit 425 may serve to perform a function of receiving this command. Further, after the image of the display is captured, the data transmission/reception unit 425 may send the captured image to the manager terminal device 300.

The display image capturing unit 427 is configured to capture an image of the front face of the display 410. Based on the current/voltage data acquired by the current/voltage measuring unit 421, it can be investigated whether or not the display is operating normally. When measuring the current/voltage, however, a noise may be generated partially, and the presence or absence of an abnormality may not be clearly detected. Furthermore, even in case it is found that there is an abnormality, it may be difficult to specify where the abnormality exists, i.e., whether the location of the abnormality is a portion which affects the entire display or a corner portion which does not affect the entire display. To compensate for such a problem in determining the presence or absence of an abnormality of the display by the current/voltage measuring unit 421, the display capturing unit 427 configured to capture an image of the front face of the display 410 is provided in the present example embodiment.

Accordingly, the display image capturing unit 427 is capable of capturing an image of the display when the manager sends a command through the manger terminal device 300 in order to investigate the state of the display 410. Further, the display image capturing unit 427 may be set to capture an image of the display periodically regardless of the command from the manager.

The display image capturing unit 427 may be implemented by a commonly known camera. Further, the display image capturing unit 427 may be installed at a corner of the display 410 or placed apart from the display 410 in order to capture the image of the front face of the display without blocking the display 410. If the display image capturing unit 427 is installed at the corner of the display 410, an angle at which the display image capturing unit 427 faces the front face of the display 410 is small, so that a part of the captured image may be distorted. In such a case, it may be difficult for the manager to determine presence or absence of an abnormality and a location of the abnormality, if any, in the example embodiment, to solve this problem, an image processing unit (not shown) may be provided so that the image obtained by the display image capturing unit 427 can be easily checked by the manager.

The control unit 429 is configured to control a flow of data and signals between the individual components of the digital signage abnormality detection apparatus 420, thus allowing the individual components of the digital signage abnormality detection apparatus 420 to perform their own functions.

According to the example embodiment as described above, an abnormality of the display 410 of the digital signage 400, if any, can be easily detected by the current/voltage measuring unit 421. Further, by using the display image capturing unit 427 provided to compensate for the function of the current/voltage measuring unit 421, presence or absence of an abnormality of the display 410 can be accurately detected, and the location of the abnormality, if any, can also be detected accurately.

### Digital Signage Abnormality Detection Method

Hereinafter, a method of detecting an abnormality of the display of the above-described digital signage will be elaborated.

First, a current or a voltage applied to the display 410 is measured by the ampere meter or the voltmeter which is connected to the display 410 of the digital signage 400. Then, a pattern of the measured current or voltage data is analyzed and compared with previously stored data.

The data previously stored to be compared with the pattern of the measured current or voltage data may be current/voltage data which may be obtained when the display is in a normal state. In this case, by determining whether the pattern of the measured current or voltage data coincides with the previously stored data, it is determined whether the current state of the display is normal.

Alternatively, the data previously stored to be compared with the pattern of the measured current or voltage data may include a multiple number of current/voltage data which correspond to various types of the abnormality (malfunction). Accordingly, by finding out which of the multiple number of current/voltage data patterns coincides with the pattern of the measured current/voltage, the current state of the display can be determined.

Meanwhile, as an operating time of the display increases, a current/voltage characteristic of the display may be varied. Accordingly, when comparing the previously stored data with the measurement data, it may be possible to compensate the previously stored data according to the operating time of the display.

Through this process, if it is determined based on the measured current or voltage that the display 410 of the digital signage 400 has no abnormality, the process may return back to the beginning and a current or a voltage applied to the display may be measured again.

If, on the other hand, it is determined based on the measured current or voltage that the display 410 has an abnormality, an abnormality signal indicating the occurrence of the abnormality in the display is sent to the manager terminal device 300.

As stated above, the digital signage according to the example embodiment is capable of monitoring whether an abnormality has occurred in the display on its own. Thus, the manager need not monitor and check the display of the digital signage directly. Particularly, in case that an abnormality occurs in the display, the occurrence of the abnormality can be informed to the manager promptly through the manager terminal device such as the smart phone. Thus, the manager can check the presence or absence of the abnormality of the display anywhere in real time.

In case that the manager receives the signal indicating the presence of the abnormality in the display through the manager terminal device, the manager may issue a command for ordering the image capturing unit such as the camera installed adjacent to the display to capture an image of the front face of the display. This image capturing process is conducted to compensate for the determination of the presence or absence of an abnormality through the measurement of the current/voltage. Through this image capturing process, not only the presence or absence of an abnormality but also the location of the abnormality, if any, may be clearly determined. Furthermore, by operating the image capturing unit only when the display is found to have an abnormality through the current/voltage measurement, consumption of cost that might be caused by operating the image capturing unit all the time can be reduced.

Meanwhile, according to the example embodiment, the image capturing of the display may not be limited to be conducted only in response to the command from the manager. That is, the image capturing may be conducted periodically without needing to receive a command from the manager. Furthermore, presence or absence of an abnormality of the digital signage may be determined just by capturing the image of the display, without regard to the measurement of the current/voltage and the analysis of the measurement data.

If the image capturing of the display is performed, the captured image may be transmitted to the manager terminal device. Here, to allow the manger to easily recognize the image of the display, the captured image of the display may be subjected to image-processing before being sent to the manger terminal device. By way of example, the image capturing unit such as the camera may be installed at the corner of the display or installed spaced apart from the display so as not to block the display when the digital signage is used. For this reason, there is a likelihood that the captured image of the display may be partially distorted. For example, the shape of the display may be distorted. According to the example embodiment, however, by compensating the captured image through the image-processing, an accurate state of the display can be informed to the manager.

As discussed above, based on the current/voltage measurement data and the captured image of the display, the manager can easily check whether an abnormality has occurred in the display and at which part of the display the abnormality exists. Therefore, even if there occurs an abnormality in the digital signage, a proper measure to the problem can be taken promptly.

The above description of the example embodiment is provided for the purpose of illustration, and it would be understood by those skilled in the art that various changes and modifications may be made without changing technical conception and essential features of the example embodiment.

Particularly, the term “digital signage” used herein should be understood as a generic term indicating a digital device which is connected with a set-top box connected to a management system composed of a cloud server and the like and is capable of outputting a controlled screen to a user. By way of non-limiting example, any of various devices that can be operated in the same or similar technical mechanism as the typical digital signage described in Background may be included in the scope of the digital signage according to the example embodiment as long as the device has a configuration in which a display of the device is mounted to an electronic device such as a TV, a refrigerator, a washing machine, an automobile, a boiler, an air conditioner, or the like, and is also connected to a set-top box and a management system such as a cloud server.

The scope of the inventive concept is defined by the following claims and their equivalents rather than by the detailed description of the illustrative embodiments. It shall be understood that all modifications and embodiments conceived from the meaning and scope of the claims and their equivalents are included in the scope of the inventive concept.

We claim:

1. A digital signage abnormality detection method of detecting presence or absence of an abnormality of a digital signage including a display, the method comprising:
measuring current or voltage data applied to the display;
determining presence or absence of an abnormality of the display by analyzing the measured current or voltage data; and
transmitting the determination result regarding the presence or absence of the abnormality of the display to a manager of the digital signage,
wherein in the process of determining presence or absence of the abnormality, the presence or absence of the abnormality is determined by comparing the measured current or voltage data with current or voltage data obtained when the display is in a normal state.

2. The digital signage abnormality detection method of claim 1,
wherein in the process of determining the presence or absence of the abnormality, a type of the abnormality of the display is determined by comparing the measured current or voltage data with a plurality of current or voltage data which correspond to abnormality types of the display.

3. The digital signage abnormality detection method of claim 1,
wherein in the process of determining the presence or absence of the abnormality, current or voltage data obtained when the display is in a normal state is compensated according to an operating time of the display and the compensated current or voltage data is compared with the measured current or voltage data.

4. The digital signage abnormality detection method of claim 1, further comprising:
capturing an image of the display.

5. The digital signage abnormality detection method of claim 4, further comprising:
compensating the captured image of the display.

6. The digital signage abnormality detection method of claim 4,
wherein the capturing the image of the display is performed in response to a command from the manager of the digital signage after the determination result regarding the presence or absence of the abnormality of the display is transmitted to the manager of the digital signage.

7. A digital signage abnormality detection apparatus which detects an abnormality of a digital signage including a display, the apparatus comprising:
a measuring unit configured to measure current or voltage data applied to the display;
a data measurement unit configured to determine presence or absence of an abnormality by analyzing the measured current or voltage data; and
a data transmission and reception unit configured to transmit the determination result obtained by the data measurement unit to a manager of the digital signage,
wherein the data measurement unit stores a current or voltage data obtained when the display is in a normal state, and determines presence or absence of the abnormality by comparing the measured current or voltage data with the stored current or voltage data.
